(19) United States
(12) Patent Application Publication
(10) Pub. No.: US 2007/0132281 A1
(43) Pub. Date: Jun. 14, 2007

(54) Roof Structure for a Trailer

(76) Inventor: Rodney P. Ehrlich, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/563,796

(22) Filed: Nov. 28, 2006

Related U.S. Application Data
(60) Provisional application No. 60/748,726, filed on Dec. 8, 2005.

(51) Int. Cl. B62D 25/06

(52) U.S. Cl. 296/210

(57) ABSTRACT

A roof structure for a trailer includes a roof sheet attached to top rails of the trailer, and a plurality of spaced apart roof bows attached to the roof sheet. The roof bows provide structural support to the roof structure and are mounted on the exterior of the trailer, such that the roof bows are exposed to the environment. The roof sheet faces the interior of the trailer and provides a smooth, snag-free interior surface on the inside of the trailer.

This application claims the domestic benefit of U.S. Provisional Application Ser. No. 60/748,726 filed on Dec. 8, 2005, which disclosure is hereby incorporated by reference.

### FIELD OF THE INVENTION

This invention is generally directed to a roof structure for a trailer, particularly a semi-trailer.

### BACKGROUND OF THE INVENTION

Prior art roof structures for trailers, particularly semi-trailers are mounted on a pair of conventional top rails which extend along the length of the trailer. The top rails are connected to respective side walls by suitable means. The roof structure is formed of a plurality of spaced apart roof bows which span the width (side to side) of the trailer and a roof sheet which is attached to an upper surface of the roof bows. As such, the roof bows are exposed to the interior of the trailer and may present a snag risk for cargo in the trailer which is proximate to the top of the trailer.

The present invention provides a roof structure which overcomes the problems presented in the prior art and which provides additional advantages over the prior art, such advantages will become clear upon a reading of the attached specification in combination with a study of the drawings.

### SUMMARY OF THE INVENTION

Briefly, the present invention discloses a roof structure for a trailer. The roof structure includes a roof sheet attached to top rails of the trailer, and a plurality of spaced apart roof bows attached to the roof sheet. The roof bows provide structural support to the roof structure and are mounted on the exterior of the trailer, such that the roof bows are exposed to the environment. The roof sheet faces the interior of the trailer and provides a smooth, snag-free interior surface on the inside of the trailer.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a top plan view of a portion of an upper end and a roof of a trailer;

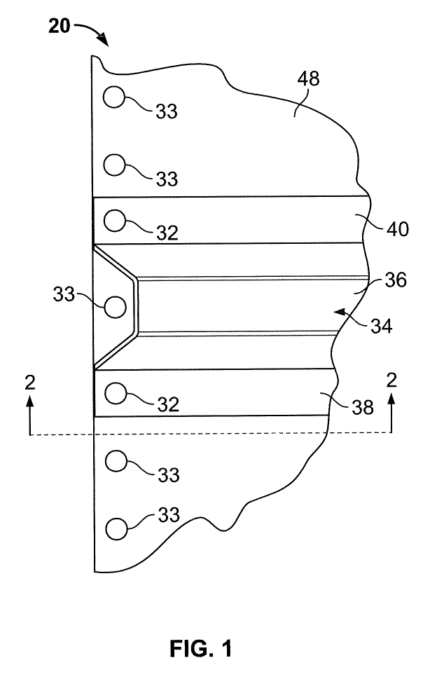

FIG. 2 is a cross-sectional view along line 2-2 of FIG. 1; and

FIG. 3 is side elevational view of the portion of the upper end and the roof of the trailer.

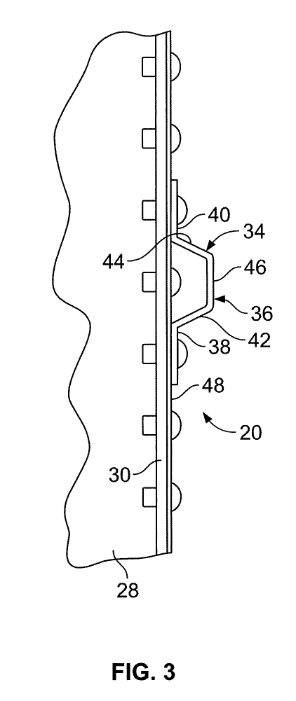

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

A roof structure 20 is provided for a trailer, particularly a semi-trailer, which hauls cargo, such as automobile parts. The roof structure 20 is mounted on a pair of top rails 22 (only one of which is shown) which extends along the length of the trailer. The top rails 22 are connected to respective side walls 23 by suitable means.

Each top rail 22 is formed of a first vertical wall 24, a second wall 26 which is perpendicular to the first vertical wall 24, a third wall 28 which is perpendicular to the second wall 26 and parallel to the first wall 24, and a fourth wall 30 which is perpendicular to the third wall 28 and parallel to the second wall 26. An upper end of the side wall 23 is connected to the first wall 24 by suitable means. The second wall 26 extends inwardly toward the interior of the trailer and covers the top end of the side wall 23. The fourth wall 30 extends outwardly from the interior of the trailer. The fourth wall 30 has a plurality of spaced apart apertures provided therethrough for acceptance of rivets 32, 33 as described herein.

The roof structure 20 is formed of a plurality of roof bows 34 which span the width (side to side) of the trailer and a flat roof sheet 48. As shown, the flat roof sheet 48 is sandwiched between the roof bows 34 and the top rails 22. This presents a smooth interior surface in the trailer. It is envisioned that the structure of the top rails 22 can be modified such that the top rails 22 are sandwiched between the edges of the roof sheet 48 and the roof bows 34, while still presenting a smooth interior surface in the trailer which is provided by the roof sheet 48. The roof bows 34 would still contact the roof sheet 48 and provide structural support to the roof sheet 48. Therefore, the important feature of the roof structure 20 is that the roof bows 34, which provide structural support, are mounted on the exterior of the trailer and exposed to the environment, such that the roof sheet 48 provides the smooth interior surface on the inside of the trailer.

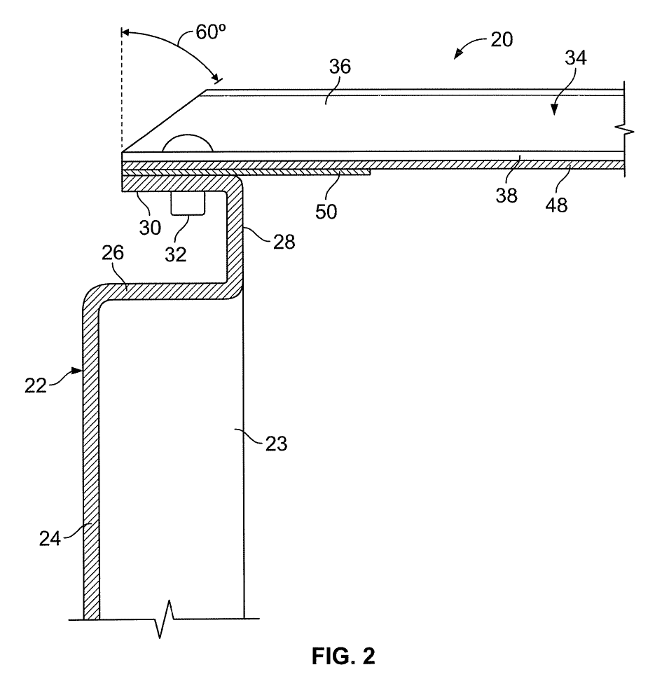

The roof bows 34 are provided at predetermined spaced apart positions along the length of the trailer. Each roof bow 34 is identically formed and attached to the respective top rails 22 in the same manner at each end of the roof bow 34. Therefore, the structure of only a single roof bow 34 is described. The roof bow 34 has a middle section 36 that has flat end sections 38, 40 extending outwardly from the opposite ends of the middle section 36. A series of apertures are provided through each of the flat end sections 38, 40 at spaced apart locations. As best shown in FIG. 2, the middle section 36 has a first wall 42 which extends upwardly at an angle from the flat end section 38, a second wall 44 which extends upwardly at an angle from the opposite flat end section 40, and a third wall 46 which connects the upper ends of the first and second walls 42, 44 together. The end of the middle section 36 is angled at a predetermined angle, preferably 60 degrees from vertical toward the interior of the trailer. As such, the roof bow 34 generally forms an upside-down hat in cross-section.

A flat roof sheet 48 is attached to the underside of the flat end sections 38, 40 of each roof bow 34 by suitable means, such as by adhesive. The roof sheet 48 is one-piece and spans the length and width of the interior of the trailer. The roof sheet 48 can be formed of multiple panels joined together by watertight joints provided there is a smooth undersurface provided in the resulting roof sheet. The roof sheet 48 is formed of a metal sheet or a strong, reinforced material, such as glass fiber reinforced plastic panels sold under the brandname KEMLITE® material or high impact, lightweight, thermoplastic composite sheets sold under the brandname BULITEX® material, or the like. Apertures are provided through the roof sheet 48 proximate to, but spaced from the side edges, and align with the apertures in the flat end sections 38, 40 of the roof bows 34 when the roof sheet 48 is mated to the roof bows 34. Additional apertures are provided through the roof sheet 48 proximate to, but spaced from the side edges, for attachment of the roof sheet 48 directly to the top rail 22.

The roof sheet 48 and the roof bows 34 are attached to the fourth walls 30 of the top rails 22. The method of attaching the roof sheet 48 and the roof bows 34 to the top rails 22 identical on both sides and therefore, only a single side of the trailer is described with the understanding that the other side is the same. The undersurface of the roof sheet 48 at its side edge abuts against the upper surface of the top rail 22. The aligned apertures in the roof sheet 48 and the roof bows 34 are aligned with the apertures through the fourth wall 30 of the top rail 22.

Thereafter, a rivet 32 is placed through each of the aligned apertures to secure the roof bows 34, the roof sheet 48 and the top rail 22 together. The remaining apertures in the roof sheet 48 are aligned with the remaining apertures through the fourth wall 30 of the top rail 22. Thereafter, a rivet 33 is placed through each of the aligned apertures to secure the roof sheet 48 and the top rail 22 together. The tool (not shown) used to mount the rivets 33 which are placed through the aligned apertures of the roof sheet 48 and the top rail 22 proximate the end of the roof bows 34, are facilitated by the angle at the end of the middle section 36 of each roof bow 34. The angle provides for sufficient space to use the tool. As a result of the construction, the rivets 32, 33 are exterior to the inside of the trailer and do not present a snag risk.

As a result of the provision of the roof sheet 48, a smooth interior surface which is strong and durable is provided on the interior of the trailer. The roof sheet 48 aids in eliminating snagging of cargo on the roof bows 34 and thus protects the roof bows 34 from damage which could be caused by cargo as it is loaded into the trailer if the roof bows 34 were left exposed.

If necessary, a sheet reinforcement 50 can be mounted between the roof sheet 48 and the top rail 22. The sheet reinforcement 50 is a flat panel that surrounds the apertures to provide additional support for the roof sheet 48 at the juncture between the roof sheet 48 and the top rail 22, and adds penetration resistance to the roof sheet 48.

As, if desired, after riveting, a cap (not shown) can be mounted in the ends of the roofs bows 34.

While a preferred embodiment of the present invention is shown and described, it is envisioned that those skilled in the art may devise various modifications of the present invention without departing from the spirit and scope of the appended claims.

The invention claimed is:

1. A roof structure for a trailer which is mounted to top rails of the trailer, said roof structure comprising:
a roof sheet having an upper surface and a lower surface, said roof sheet being capable of being attached to the top rails; and
a plurality of spaced apart roof bows proximate to said upper surface of said roof sheet, such that said roof bows are exposed on an exterior surface of the trailer and said lower surface of said roof sheet faces the interior of the trailer,
said roof sheet and said roof bows being connected together.

2. A roof structure as defined in claim 1, further including a reinforcement attached to said roof sheet.

3. A roof structure as defined in claim 2, wherein said lower surface of said roof sheet seats against said reinforcement.

4. A roof structure as defined in claim 1, wherein said roof sheet is a is one-piece and spans the length and width of the interior of the trailer.

5. A roof structure as defined in claim 1, wherein said roof sheet is formed of metal.

6. A roof structure as defined in claim 1, wherein said roof sheet is formed of glass fiber reinforced plastic.

7. A roof structure as defined in claim 1, wherein said roof sheet is formed of high impact, lightweight, thermoplastic composite.

8. A structure for a trailer comprising:
a pair of top rails;
a roof sheet having an upper surface and a lower surface, said roof sheet being attached to said top rails; and
a plurality of spaced apart roof bows proximate to said upper surface of said roof sheet, such that said roof bows are exposed on an exterior surface of the trailer and said lower surface of said roof sheet faces the interior of the trailer,
said top rails, said roof sheet and said roof bows being connected together.

9. A structure as defined in claim 8, wherein said roof sheet is sandwiched between said top rails and said roof bows.

10. A structure as defined in claim 8, wherein said lower surface of said roof sheet seats against said top rails.

11. A structure as defined in claim 10, further including rivets for attaching said roof bows, said roof sheets and said top rails together.

12. A structure as defined in claim 11, wherein each said top rail includes a first vertical leg and a second horizontal leg which extends outwardly from an upper end of said first vertical leg and outwardly from an interior surface of the trailer, said rivets being mounted through said second horizontal leg of each top rail.

13. A structure as defined in claim 12, wherein each said top rail further includes a third horizontal leg which extends outwardly from an lower end of said first vertical leg and extends outwardly from an interior surface of the trailer, and a fourth vertical leg extending from an outer end of said third horizontal leg, and a sidewall is attached to each said fourth vertical leg.

14. A structure as defined in claim 11, wherein the ends of each said roof bow is angled at approximately 60°.

15. A structure as defined in claim 1, further including a reinforcement provided between said roof sheet and each of said top rails.

16. A structure as defined in claim 15, wherein said lower surface of said roof sheet seats against said reinforcement.

17. A structure as defined in claim 15, further including rivets for attaching said roof bows, said roof sheets, said reinforcements and said top rails together.

18. A structure as defined in claim 17, wherein each said top rail includes a first vertical leg and a second horizontal leg which extends outwardly from an interior surface of the trailer, said rivets being mounted through said second horizontal leg of each top rail.

19. A structure as defined in claim 18, further including rivets for attaching said roof bows, said roof sheets and said top rails together.

20. A structure as defined in claim 1, wherein said roof sheet is a is one-piece and spans the length and width of the interior of the trailer.
